(19) United States
(12) Patent Application Publication
(10) Pub. No.: US 2018/0311760 A1
(43) Pub. Date: Nov. 1, 2018

(54) POWDER-BED FUSION BEAM SCANNING

(71) Applicant: DIVERGENT TECHNOLOGIES, INC., Los Angeles, CA (US)

(72) Inventors: Eahab Nagi EL NAGA, Topanga, CA (US); John Russell BUCKNELL, El Segundo, CA (US); Chor Yen YAP, Gardena, CA (US)

(21) Appl. No.: 15/582,470

(22) Filed: Apr. 28, 2017

(51) Int. Cl. B23K 15/02; B33Y 10/00; B33Y 30/00; B23K 15/00; B23K 26/342; B23K 26/03; B23K 26/06; B23K 26/082; B23K 26/60

(52) U.S. Cl. CPC B23K 15/02; B33Y 10/00; B33Y 30/00; B23K 15/0086; B23K 15/0033; B23K 26/60; B23K 26/342; B23K 26/034; B23K 26/0626; B23K 26/082; B23K 15/0013

(57) ABSTRACT

Systems and methods for beam scanning for powder bed fusion (PBF) systems are provided. A PBF apparatus can include a structure that supports a layer of powder material, an energy beam source that generates an energy beam, and a deflector that applies the energy beam to fuse an area of the powder material in the layer at multiple locations, the deflector being further configured to apply the energy beam to each of the locations multiple times. A PBF apparatus can include a deflector configured to provide multiple scans to a layer powder material supported by the structure. A PBF apparatus can include a deflector that applies the energy beam to fuse an area of the powder material in the layer at multiple locations, the deflector being further configured to apply the energy beam in a raster scan.

### BACKGROUND

### Field

The present disclosure relates generally to powder-bed fusion (PBF) systems, and more particularly, to beam scanning in PBF systems.

### Background

PBF systems can produce structures, referred to as build pieces, with geometrically complex shapes, including some shapes that are difficult or impossible to create with conventional manufacturing processes. PBF systems create build pieces layer by layer. Each layer or ‘slice’ is formed by depositing a layer of powder and exposing portions of the layer to an energy beam. The energy beam is applied to melt areas of the powder layer that coincide with the cross-section of the build piece in the layer. The melted powder cools and fuses to form a slice of the build piece. Each layer is deposited on top of the previous layer. The resulting structure is a build piece assembled slice-by-slice from the ground up.

More specifically, the energy beam melts the powder into a pool of liquid, called a melt pool, at the spot the energy beam is exposing. The energy beam then scans across the powder layer and ‘pushes’ the melt pool by continually melting powder at the exposure spot of the beam.

### SUMMARY

Several aspects of apparatuses and methods for beam scanning in PBF systems will be described more fully hereinafter.

In various aspects, an apparatus for powder-bed fusion can include a structure that supports a layer of powder material, an energy beam source that generates an energy beam, and a deflector that applies the energy beam to fuse an area of the powder material in the layer at multiple locations, the deflector being further configured to apply the energy beam to each of the locations multiple times.

In various aspects, an apparatus for powder-bed fusion can include a powder material support structure, an energy beam source directed to the powder material support surface, and a deflector configured to provide multiple scans to a layer powder material supported by the structure.

In various aspects, an apparatus for powder-bed fusion can include a structure that supports a layer of powder material, an energy beam source that generates an energy beam, and a deflector that applies the energy beam to fuse an area of the powder material in the layer at multiple locations, the deflector being further configured to apply the energy beam in a raster scan.

In various aspects, a method for powder-bed fusion can include supporting a layer of powder material, generating an energy beam, and applying the energy beam to fuse an area of the powder material in the layer at multiple locations, the energy beam being applied to each of the locations multiple times.

In various aspects, a method for powder-bed fusion can include supporting a layer of powder material, generating an energy beam, and applying the energy beam to fuse an area of the powder material in the layer at multiple locations, wherein the energy beam is applied in a raster scan.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIGS. 1A-D illustrate an example PBF system during different stages of operation.

FIG. 2 illustrates an exemplary energy beam source and deflector system.

FIGS. 3A-B illustrate a perspective view of an exemplary powder bed before and after a layer of powder is deposited.

FIGS. 4A-C illustrate an exemplary vector scanning method for PBF.

FIGS. 5A-D illustrate an exemplary raster scanning method for PBF.

FIG. 6 illustrates another exemplary raster scanning method for PBF.

FIG. 7 is a flowchart of an exemplary method of raster scanning for PBF.

FIGS. 8A-C illustrate an exemplary raster scanning method including subdividing the PBF work area.

FIGS. 9A-D illustrate an exemplary multi-pass scanning method.

FIG. 10 is a flowchart of an exemplary method of multi-pass scanning for PBF.

FIG. 11 illustrates an exemplary multi-pass controlled temperature profile of a fusing area.

FIG. 12 is a flowchart of an exemplary method of multi-pass temperature profile control for PBF.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

This disclosure is directed to beam scanning in PBF systems. In various embodiments, an energy beam can be applied in a raster scan. In an example of a raster scan system, the electron beam may be swept across a rectangular work area, one row at a time from top to bottom. As the electron beam moves across each row, the beam intensity is turned on and off to create a pattern that can be used to define a cross-section of a build piece for that layer. In some embodiments, the entire area can be scanned at a rate of 1-50 cycles per second. In this way, for example, the entire area of a slice can be heated in such a short amount of time that the entire slice is essentially heated at once. More specifically, the rate of scanning can be faster than the rate that heat conducts away from the heated powder, such that at the end of the scan the temperature of the entire slice is essentially the same.

A field can be generated by either magnetics or electrostatics in such a manner to scan left and right (horizontally) at a high frequency (e.g., 10 Khz) to form a line, then scanning the line fore and aft (vertically) at a slower rate such that the entire area can be exposed. The aspect ratio of horizontal to vertical relations can be variable depending on the deflection forces and scan rates. The electron beam generation can be modulated by a digital signal processor (DSP) and appropriate power electronics in such a manner that will only expose the desired area. In other embodiments, the electron beam generation can be modulated by other dedicated hardware or by one or more processors under software control.

In contrast to vector scanning, slices can be described similarly to a digital image with pixels. The work area can be divided up into a set of rows (x) and columns (y) such that the resolution of the build piece will be X by Y pixels. The image scale can be scaled such that the resolution of the system can yield varying pixel densities (microns/pixel). The only limit of resolution would be the limitation of the electron beam gun's bandwidth of modulation. The electron beam can be modulated by, for example, modulating the cathode voltage, modulating the relative grid voltage, etc. The electron beam gun can also be configured with additional grids/plates similar to a vacuum tube tetrode or pentode to allow better modulation gains and subsequently higher modulation bandwidth.

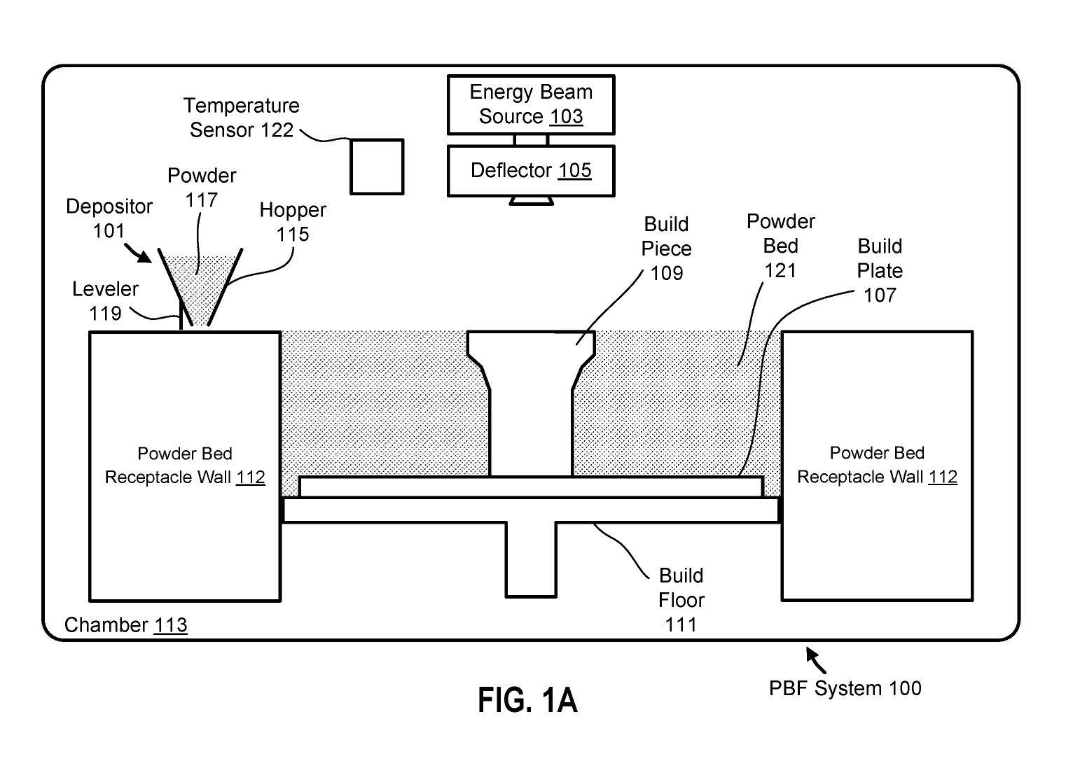

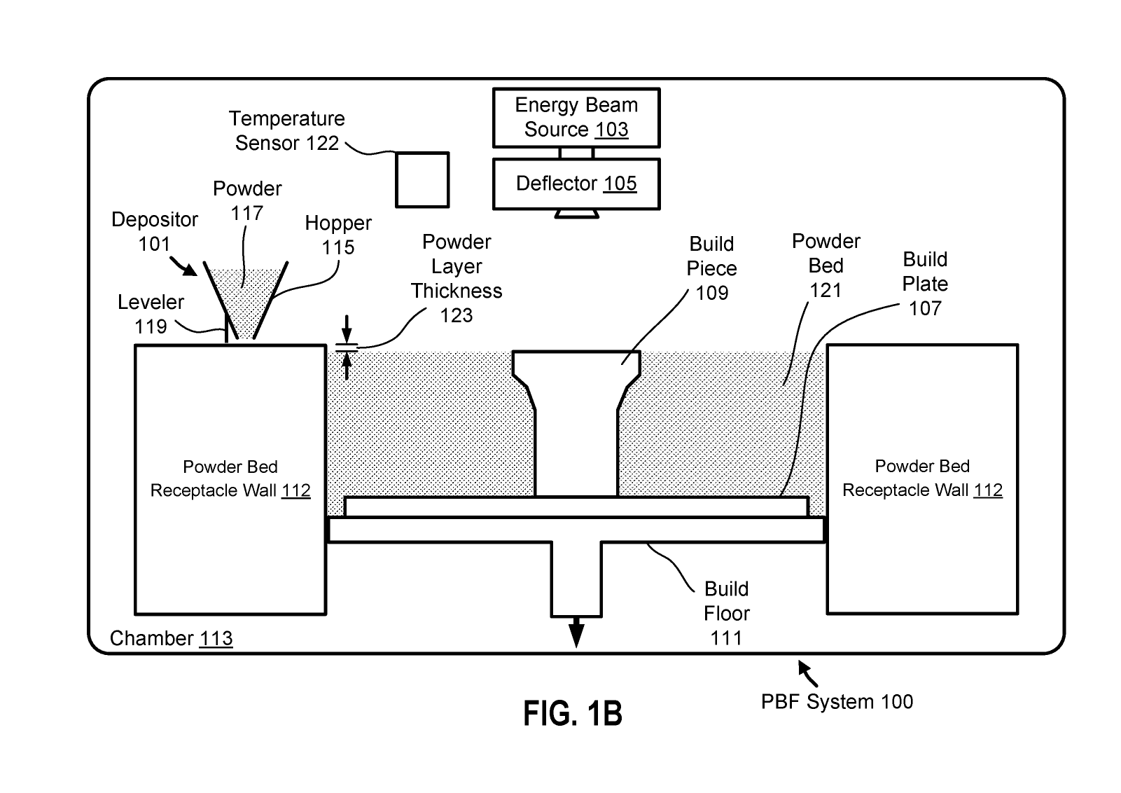

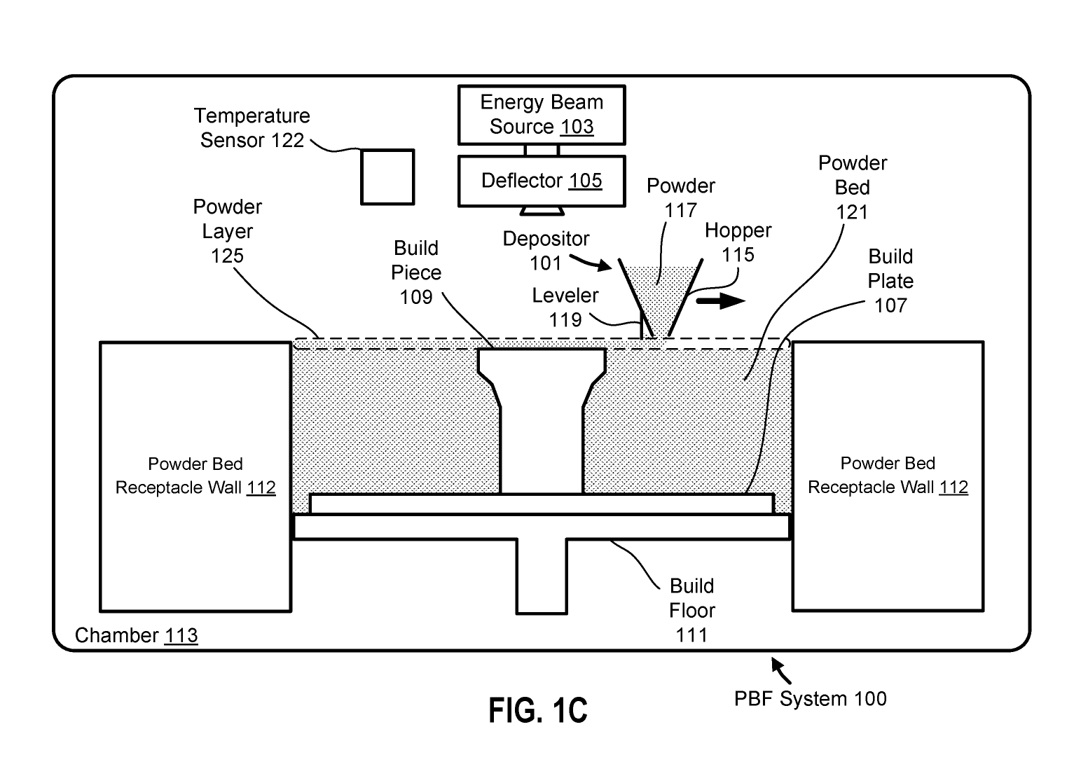

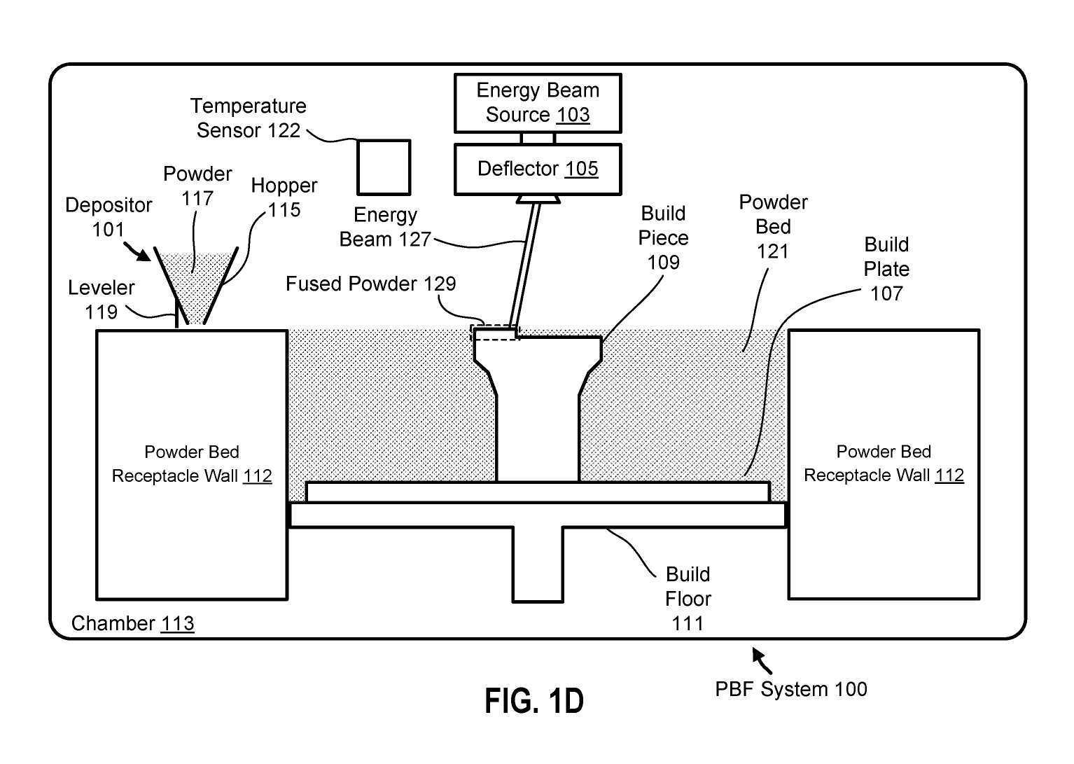

FIGS. 1A-D illustrate an example PBF system 100 during different stages of operation. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. PBF system 100 can also include a build floor 111 positioned within a powder bed receptacle. The walls of the powder bed receptacle are shown as powder bed receptacle walls 112. Build floor 111 can lower build plate 107 so that depositor 101 can deposit a next layer and a chamber 113 that can enclose the other components. Depositor 101 can include a hopper 115 that contains a powder 117, such as a metal powder, and a leveler 119 that can level the top of each layer of powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 50 layers, to form the current state of build piece 109, e.g., formed of 50 slices. The multiple layers already deposited have created a powder bed 121, which includes powder that was deposited but not fused. PBF system 100 can include a temperature sensor 122 that can sense the temperature in areas of the work area, such as the surface of powder bed, build piece 109, etc. For example, temperature sensor 122 can include a thermal camera directed toward the work area, thermocouples attached to areas near the powder bed, etc.

FIG. 1B shows PBF system 100 at stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by the powder layer thickness. In this way, for example, a space of with a consistent thickness equal to powder layer thickness 123 can be created over the tops of build piece 109 and powder bed 121.

FIG. 1C shows PBF system 100 at a stage in which depositor 101 can deposit powder 117 in the space created over the top of build piece 109 and powder bed 121. In this example, depositor 101 can cross over the space while releasing powder 117 from hopper 115. Leveler 119 can level the released powder to form a powder layer 125 that has a thickness of powder layer thickness 123. It should be noted, that elements of FIGS. 1A-D and the other figures in this disclosure are not necessarily drawn to scale, but may be drawn larger or smaller for the purpose of better illustration of concepts described herein. For example, the illustrated thickness of powder layer 125 (i.e., powder layer thickness 123) is greater than an actual thickness used for the example 50 previously-deposited layers.

FIG. 1D shows PBF system 100 at a stage in which energy beam source 103 can generate an energy beam 127 and deflector 105 can apply the energy beam to fuse the next slice in build piece 109. In various embodiments, energy beam source 103 can be an electron beam source, energy beam 127 can be an electron beam, and deflector 105 can include deflection plates that can generate an electric field that deflects the electron beam to scan across areas to be fused. In various embodiments, energy beam source 103 can be a laser, energy beam 127 can be a laser beam, and deflector 105 can include an optical system that can reflect and/or refract the laser beam to scan across areas to be fused. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

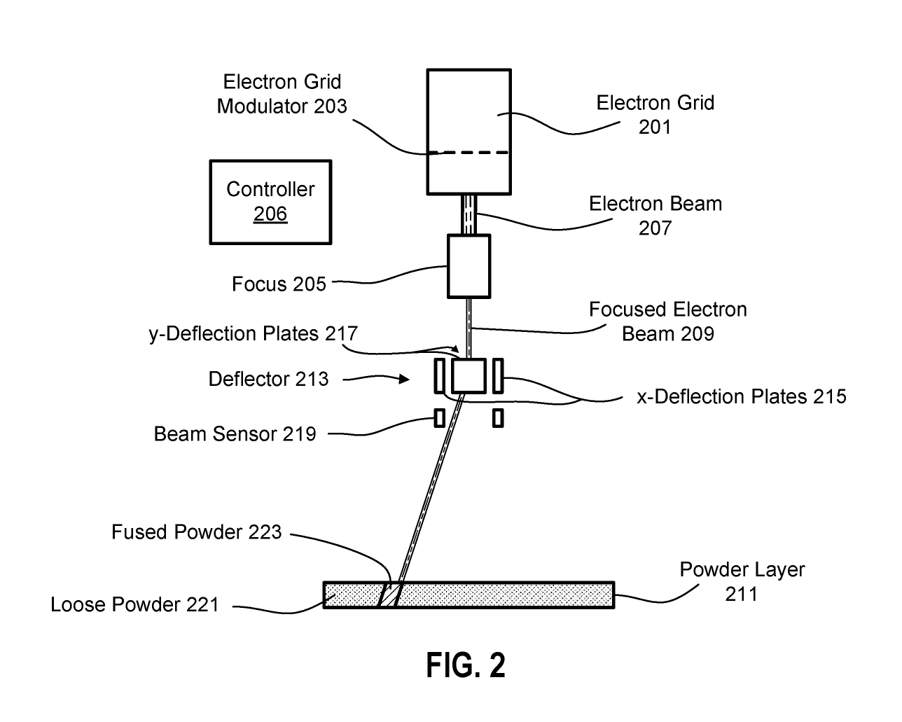

FIG. 2 illustrates an exemplary energy beam source and deflector system. In this example, the energy beam is an electron beam. The energy beam source can include an electron grid 201, an electron grid modulator 203, and a focus 205. A controller 206 can control electron grid 201 and electron grid modulator 203 to generate an electron beam 207 and can control focus 205 to focus electron beam 207 into a focused electron beam 209. To provide a clearer view in the figure, connections between controller 206 and other components are not shown. Focused electron beam 209 can be scanned across a powder layer 211 by a deflector 213. Deflector 213 can include two x-deflection plates 215 and two y-deflection plates 217, one of which is obscured in FIG. 2. Controller 206 can control deflector 213 to generate an electric field between x-deflection plates 215 to deflect focused electron beam 209 along the x-direction and to generate an electric field between y-deflection plates 217 to deflect the focused electron beam along the y-direction. In various embodiments, a deflector can include one or more magnetic coils to deflect the electron beam.

A beam sensor 219 can sense the amount of deflection of focused electron beam 209 and can send this information to controller 206. Controller 206 can use this information to adjust the strength of the electric fields in order to achieve the desired amount of deflection. Focused electron beam 209 can be applied to powder layer 211 by scanning the focused electron beam to melt loose powder 221, thus forming fused powder 223.

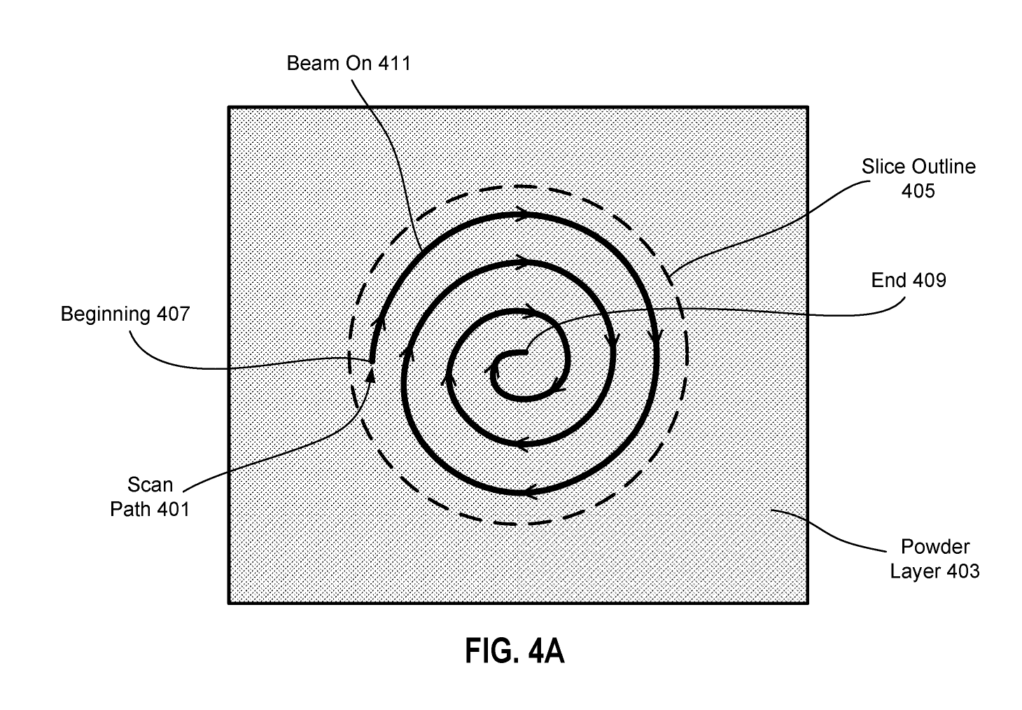

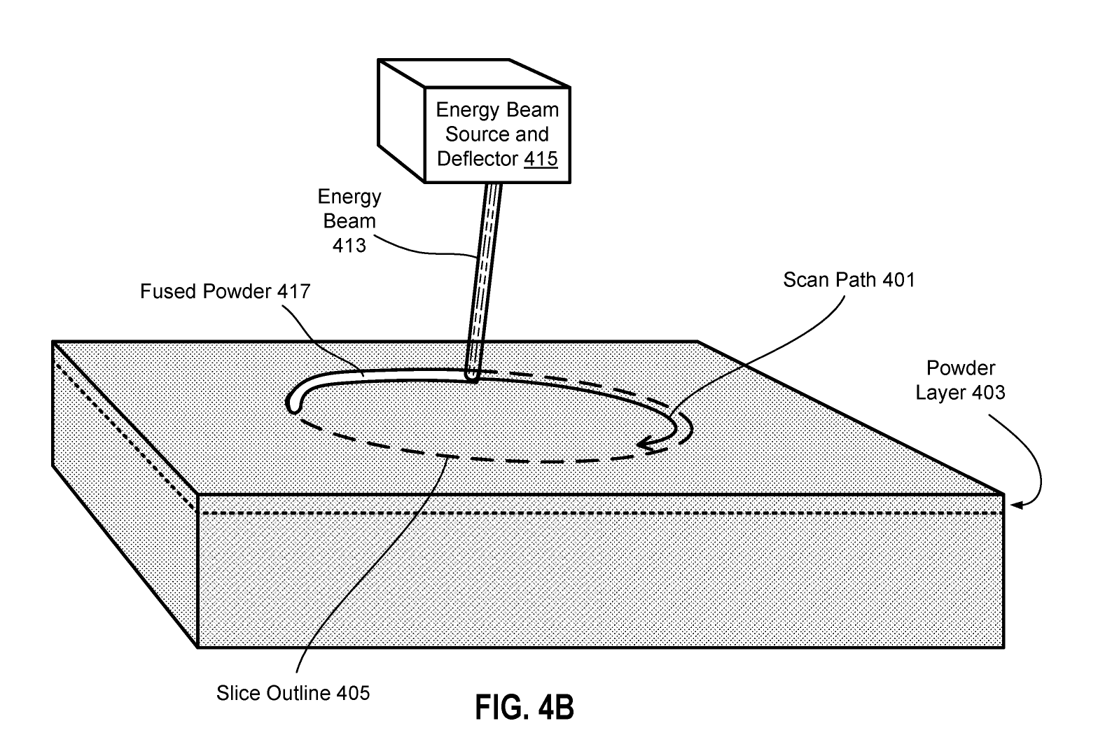

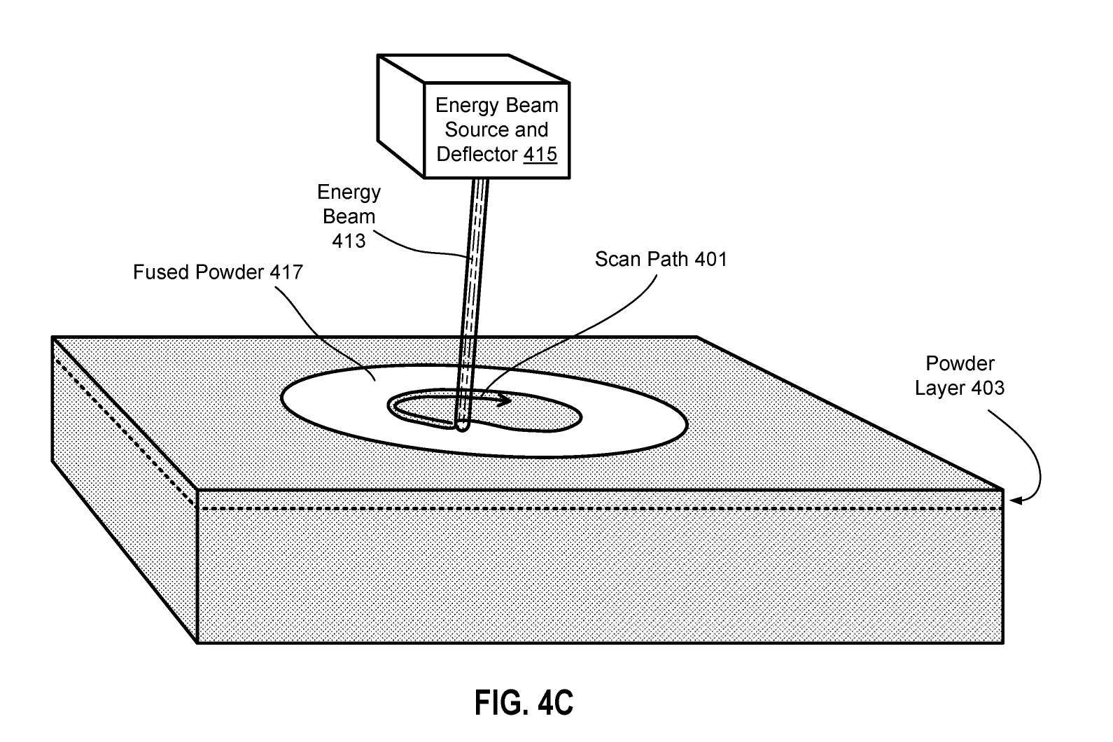

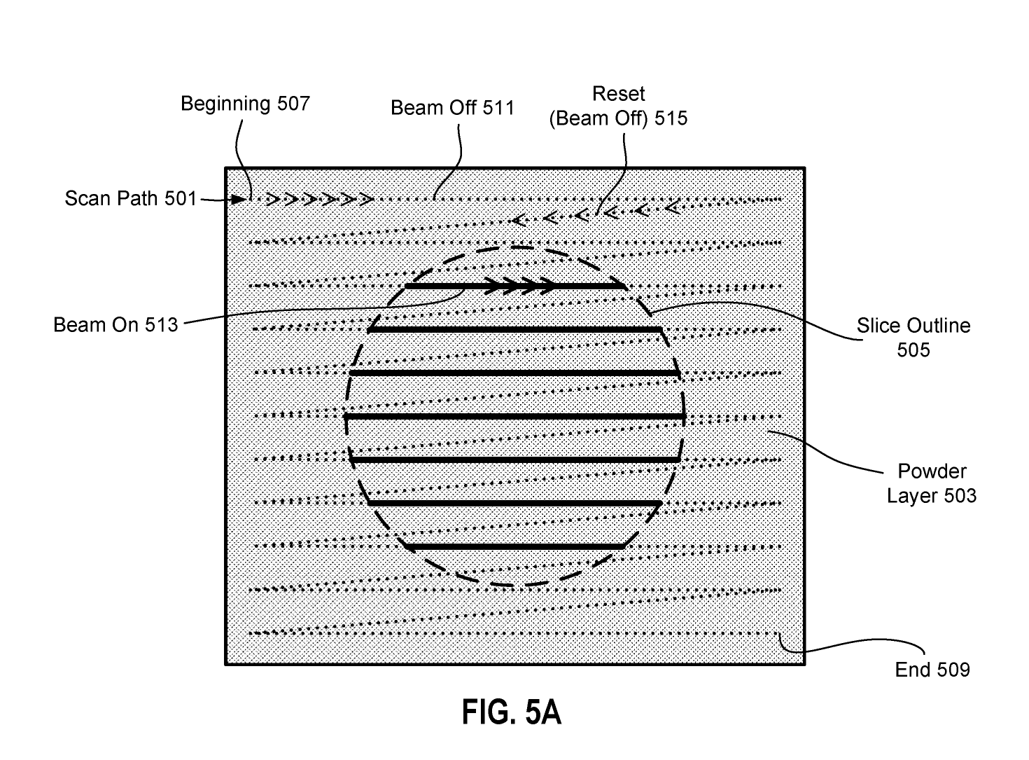

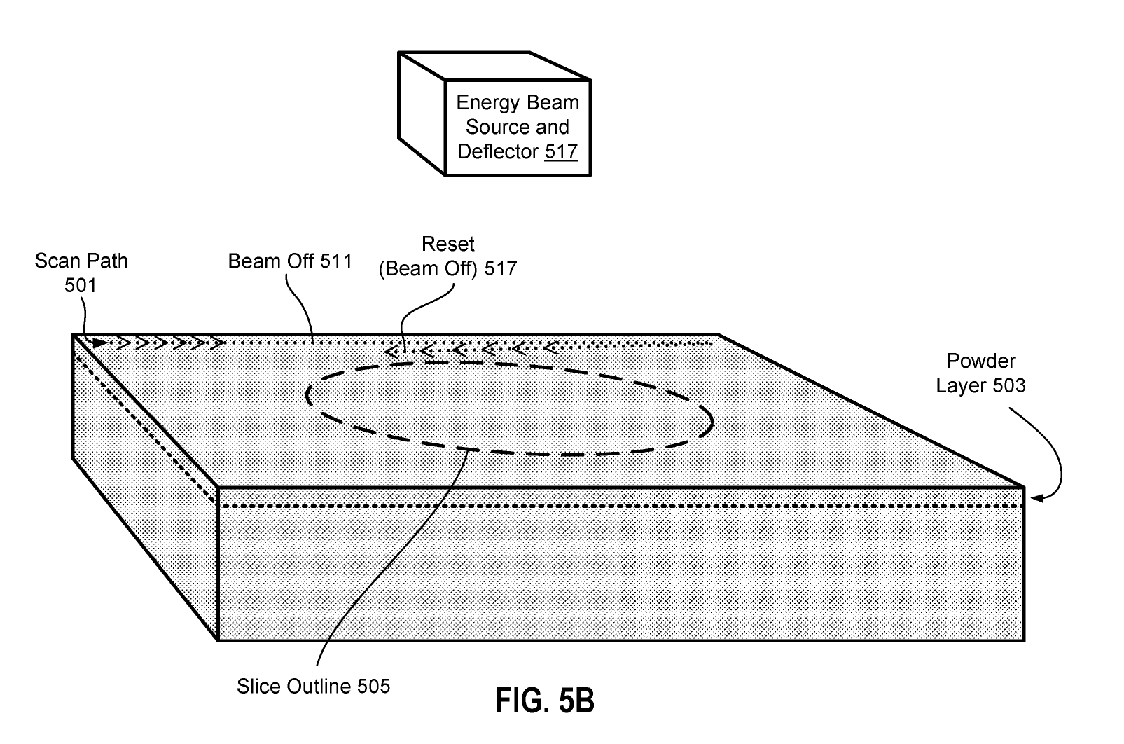

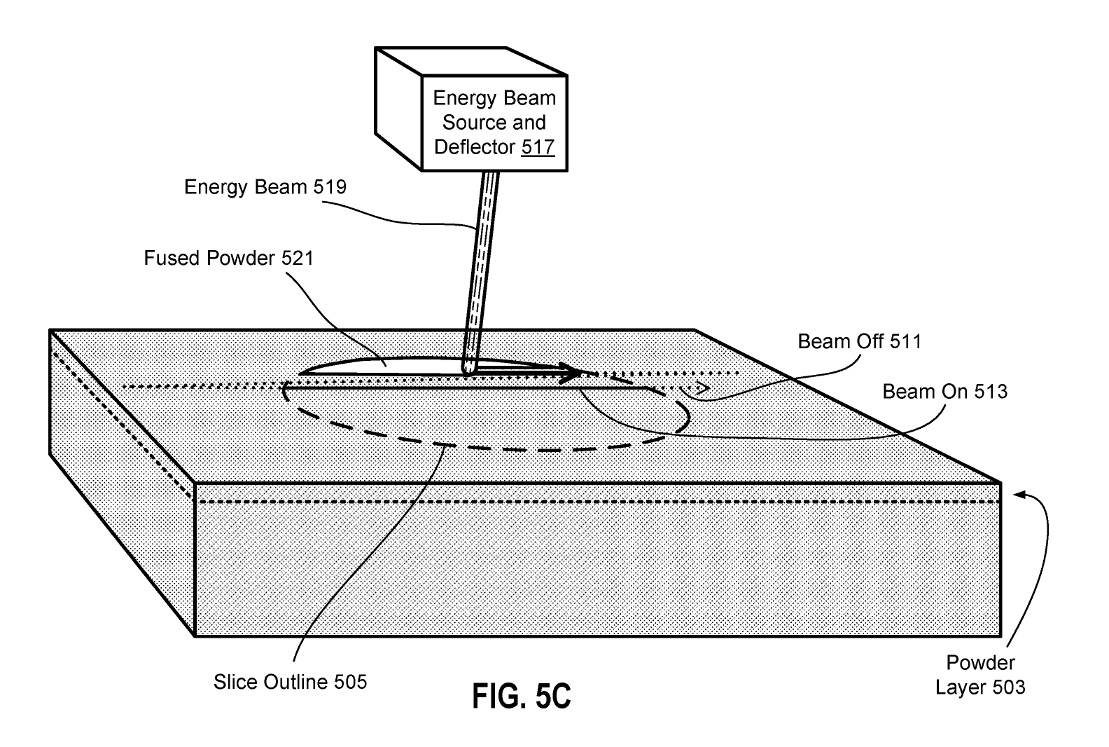

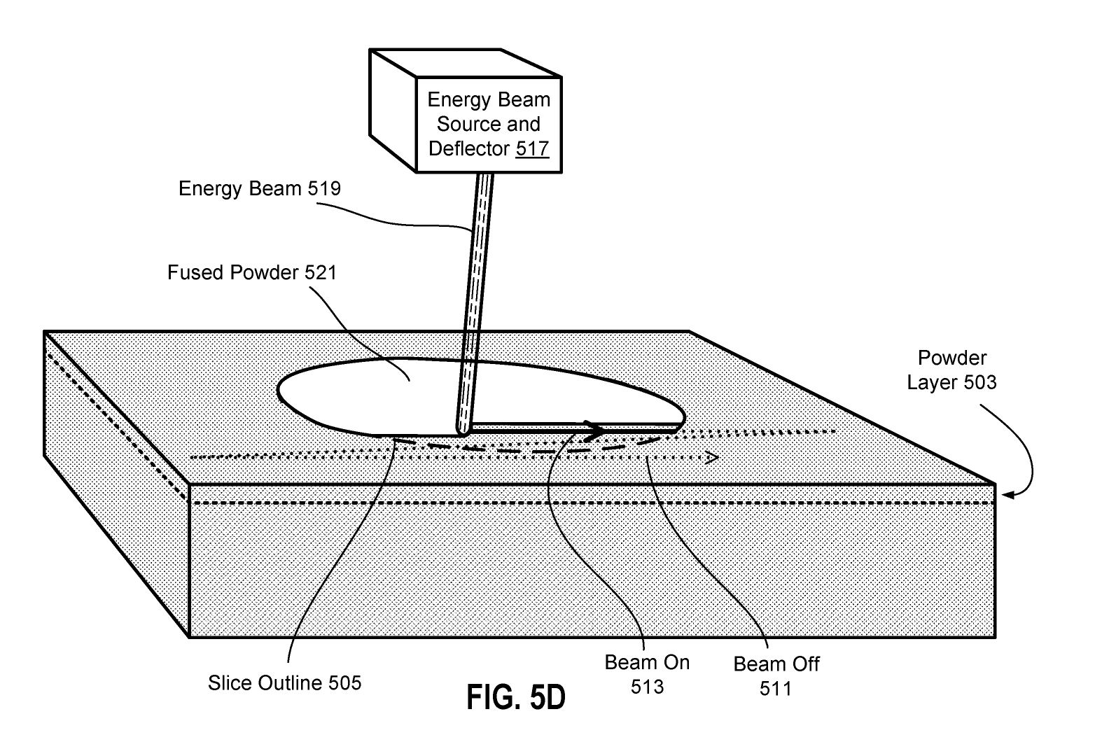

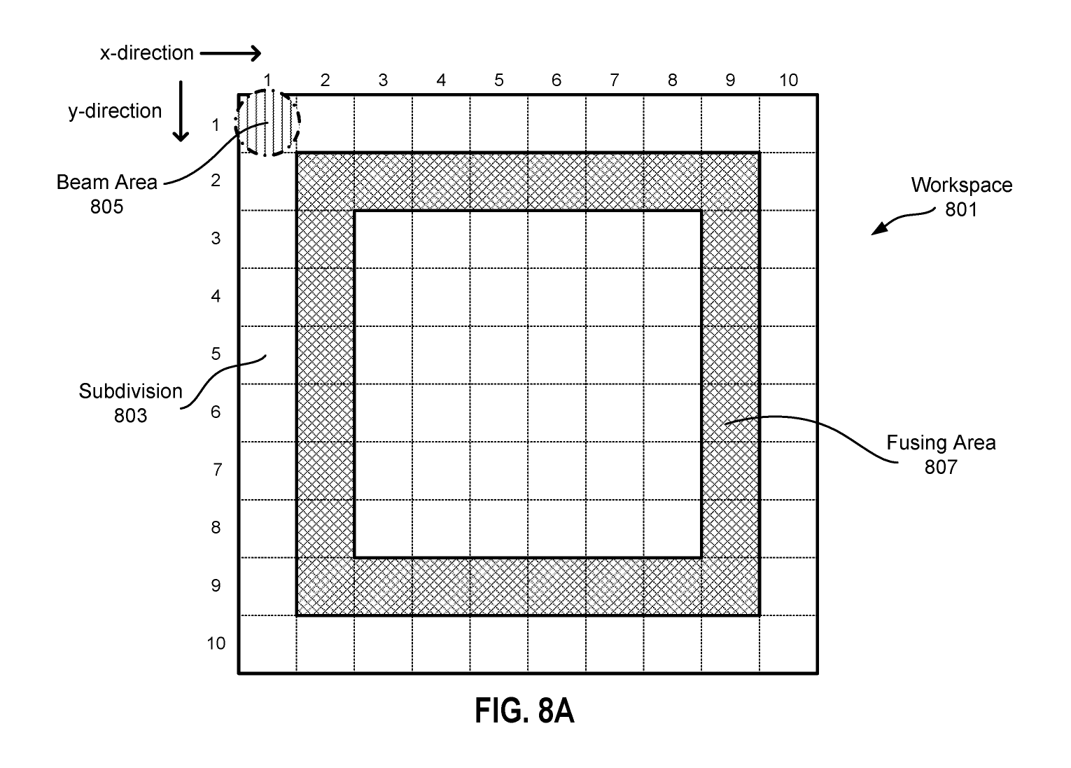

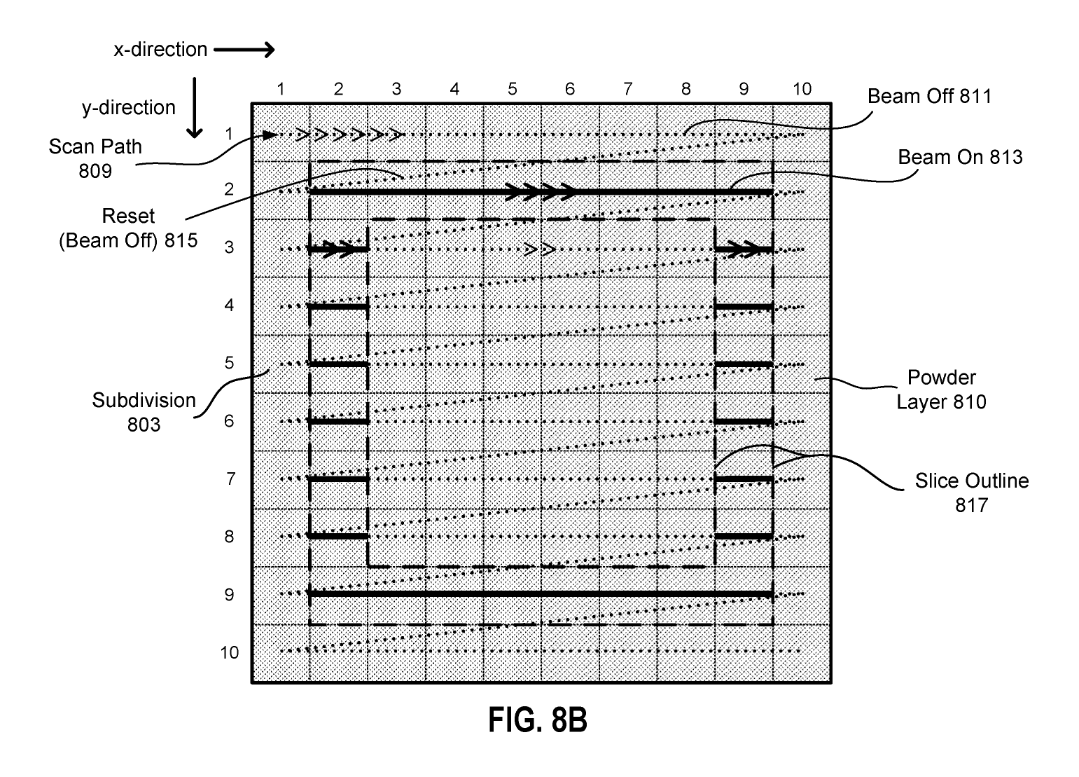

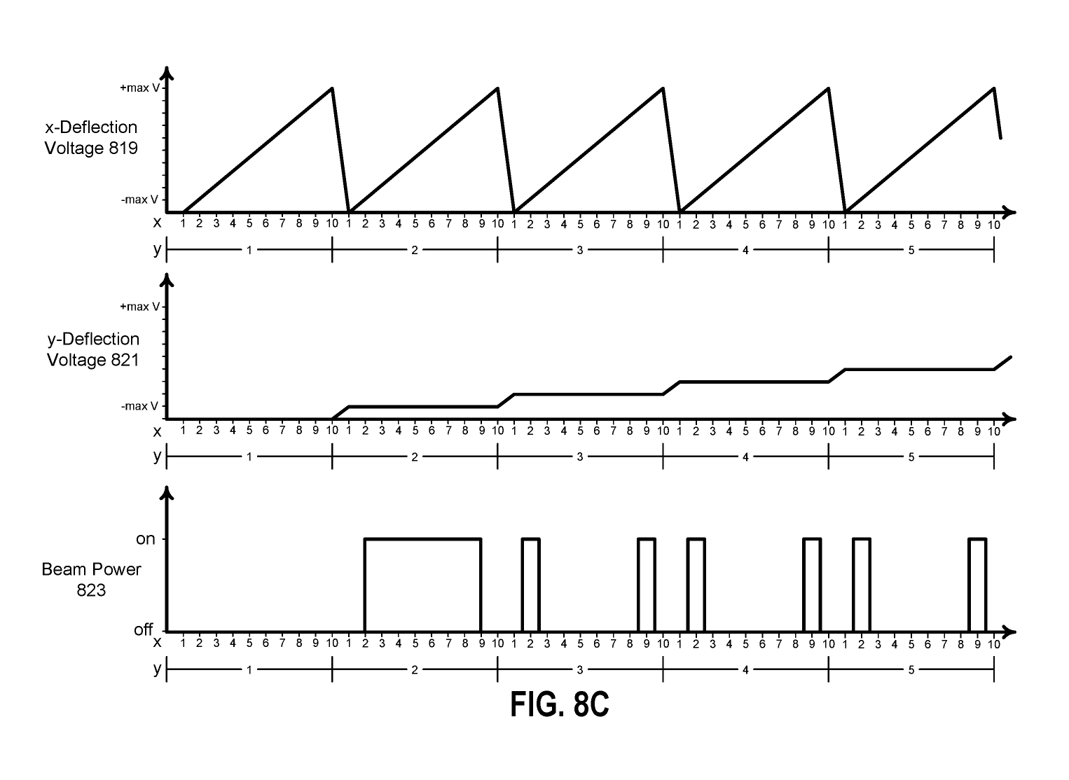

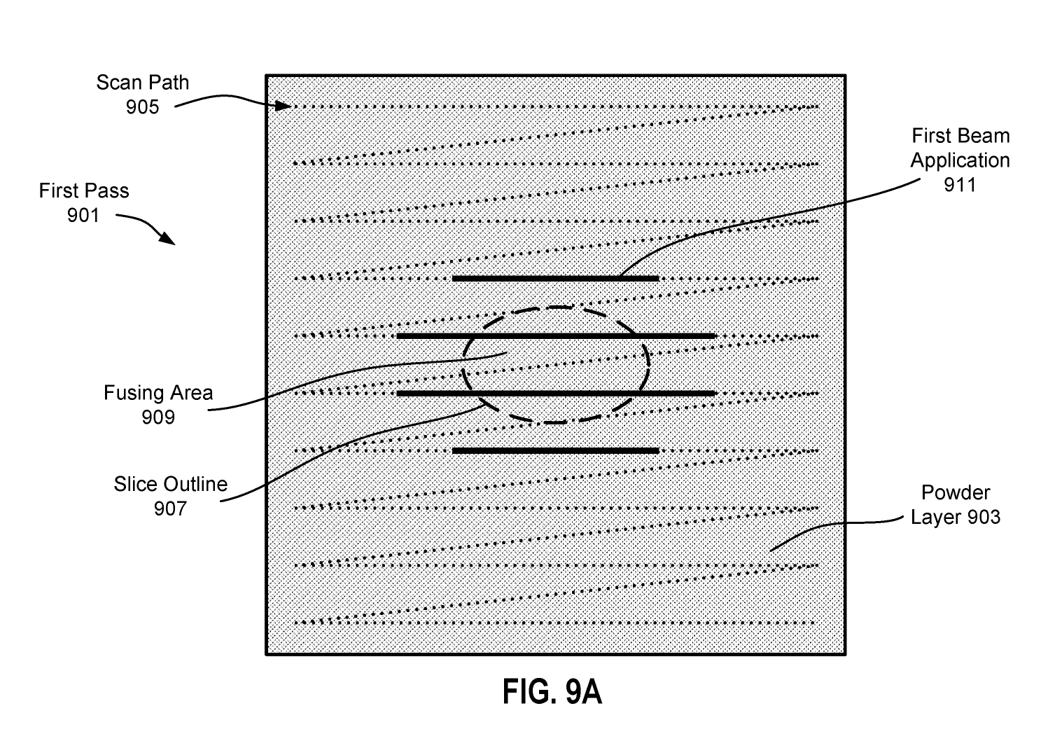

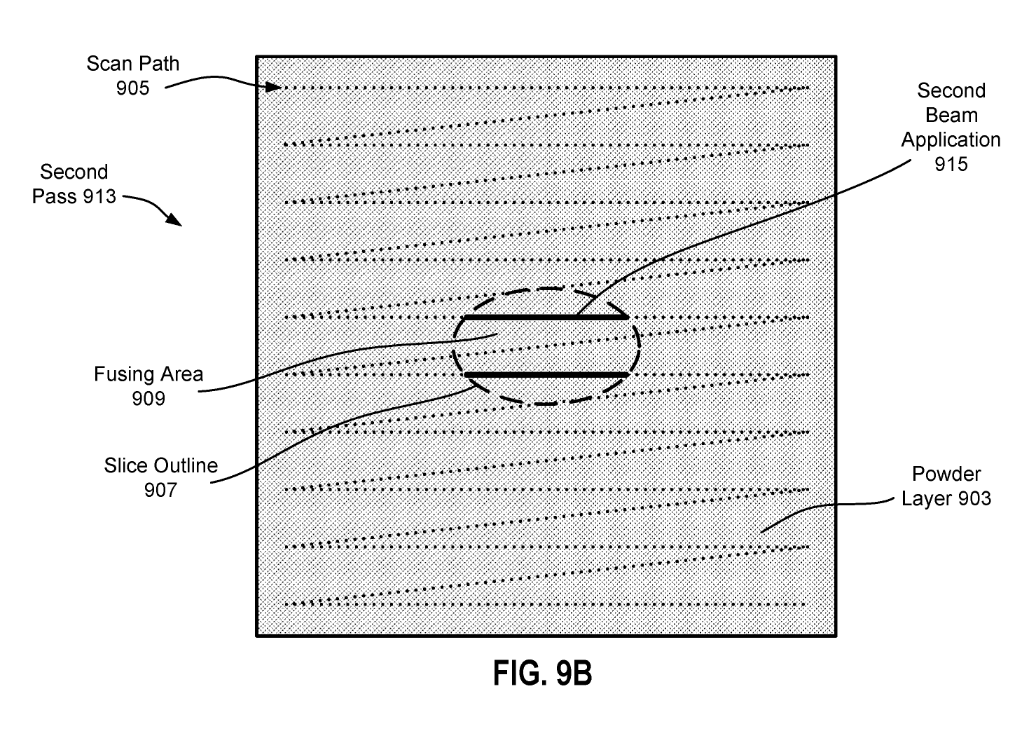

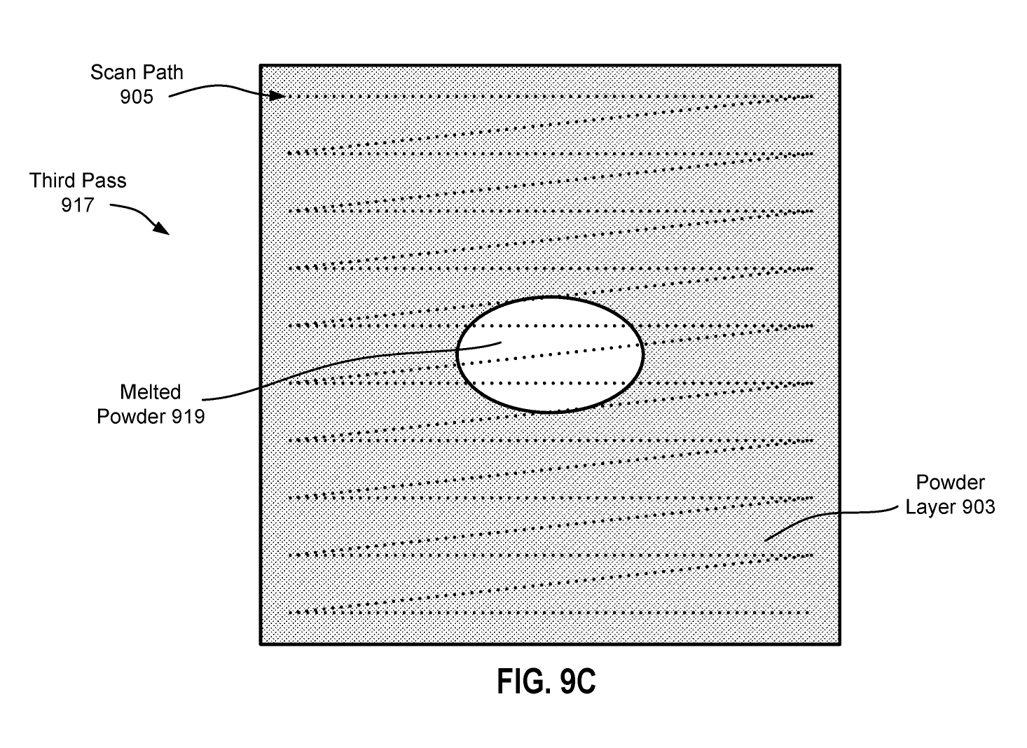

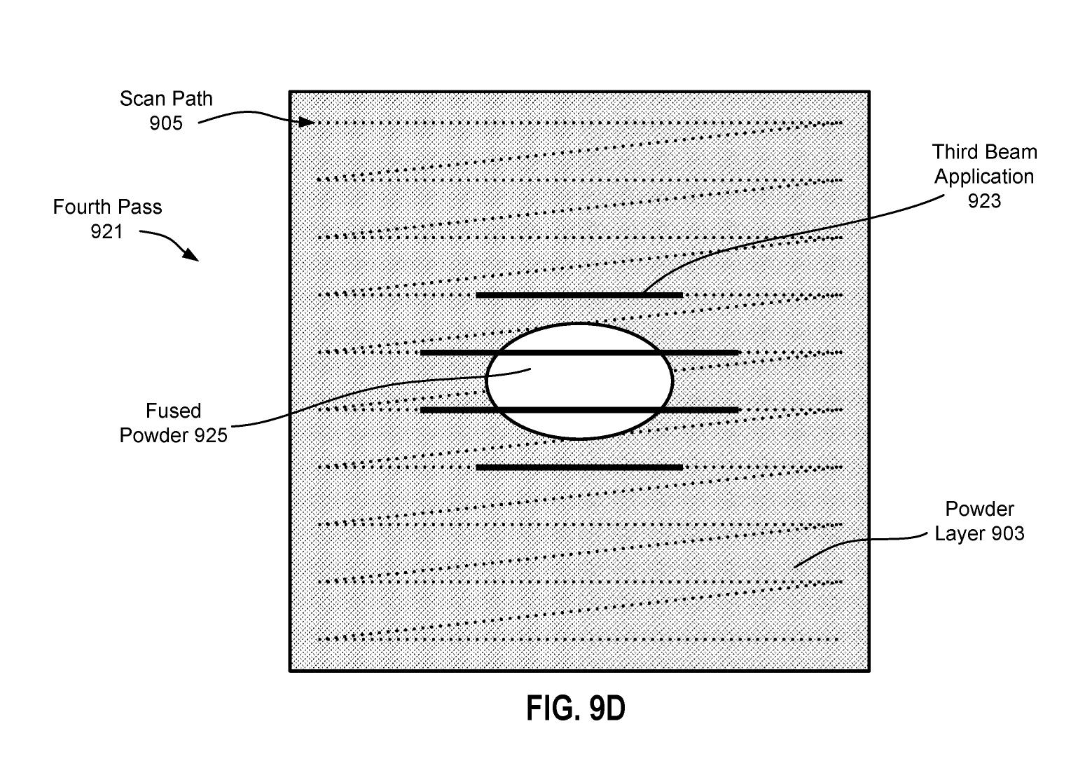

In various embodiments, an energy beam can be applied by raster scanning. FIGS. 5A-D, 6, and 7 illustrate exemplary embodiments of applying a PBF energy beam by raster scanning. In some embodiments, the raster scanning can include dividing the work area into subdivisions, which may provide an efficient way to characterize the cross-section of the build piece in each layer. FIGS. 8A-C illustrate an exemplary embodiment including subdivisions for raster scanning a PBF energy beam. In various embodiments, the energy beam can be applied by multi-pass scanning, in which the energy beam is scanned across the work area multiple times for a single fusing operation. FIGS. 9A-D and 10 illustrate an exemplary embodiment of multi-pass scanning for a PBF energy beam. In some embodiments, multi-pass scanning can be used to control a temperature profile of the build piece, an area including the build piece, the entire powder layer, etc. FIGS. 9A-D, 11, and 12 illustrate an exemplary embodiment of multi-pass scanning including temperature profile control. In some embodiments, multi-pass scanning can be used with vector scanning. FIGS. 4A-C illustrate an example of vector scanning.

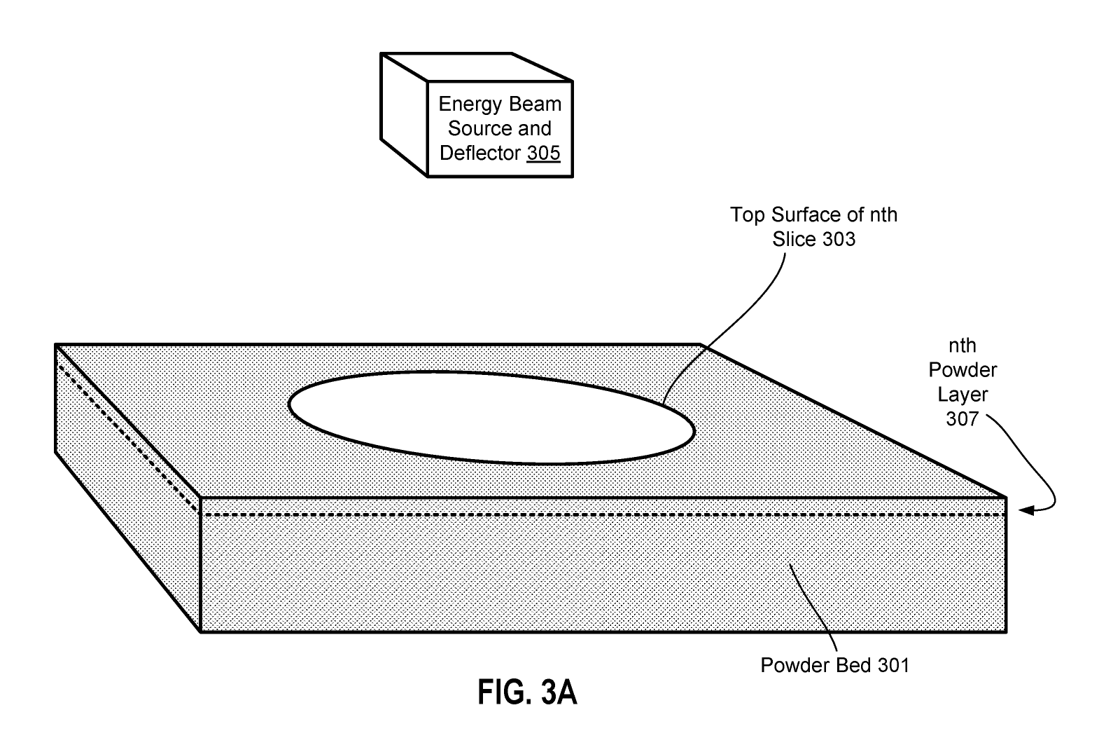

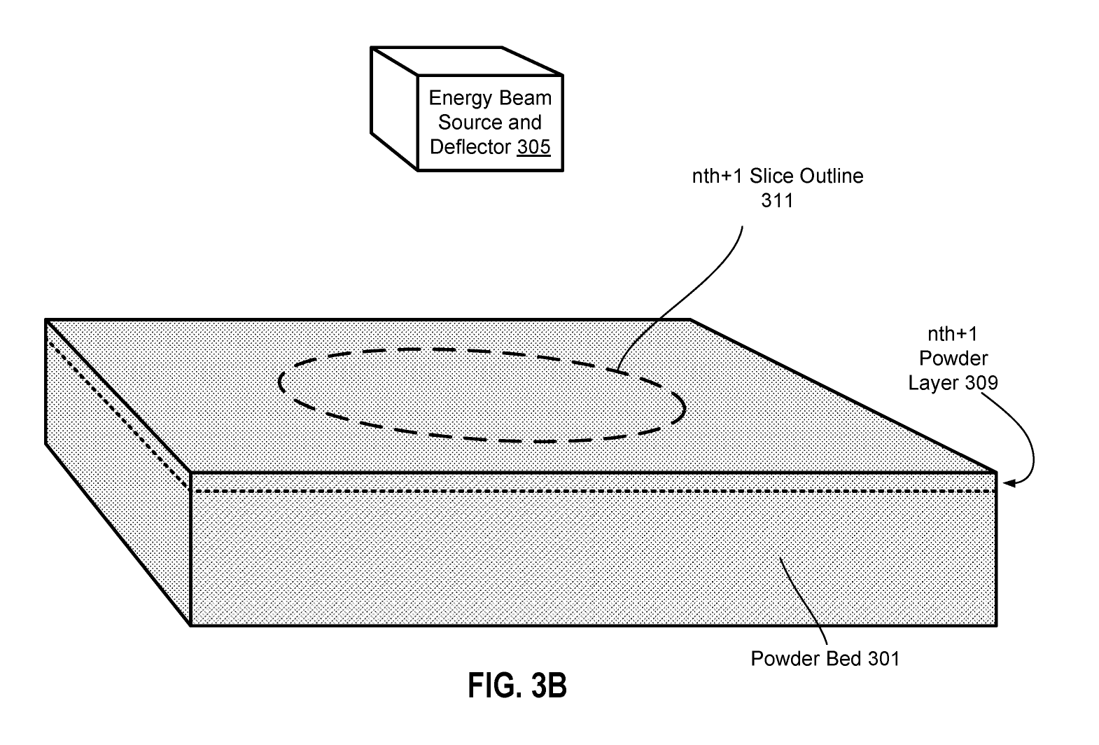

Various PBF beam scanning examples in this disclosure are illustrated using perspective views. FIGS. 3A-B provide a context for this perspective view.

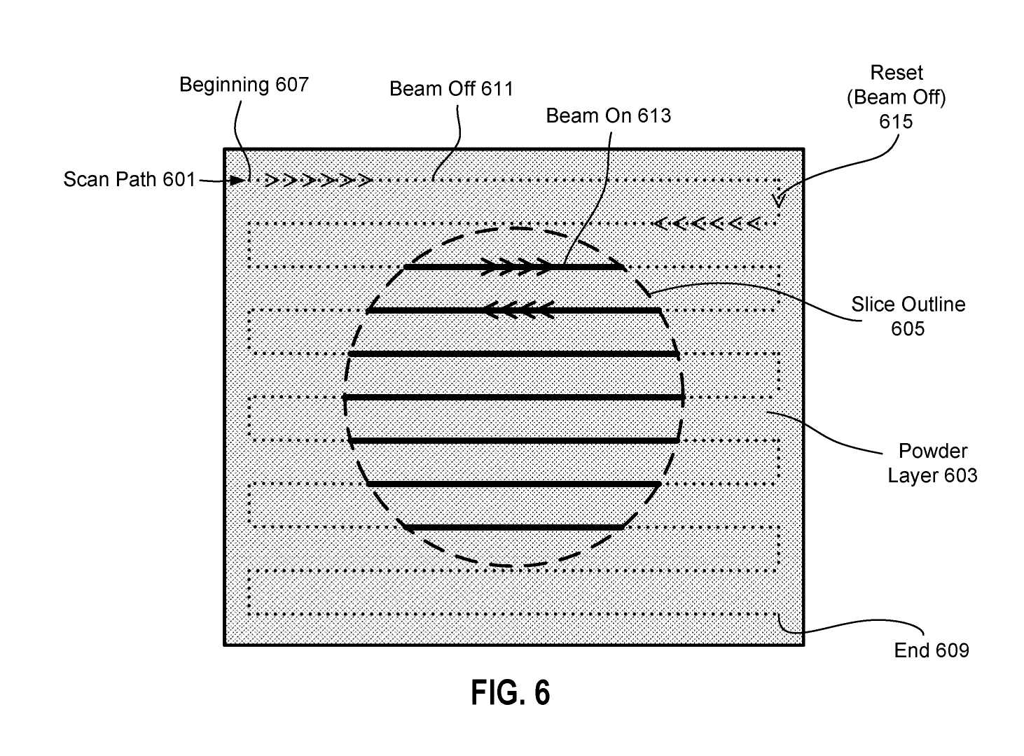

FIGS. 3A-B illustrate a perspective view of an exemplary powder bed before and after a layer of powder is deposited. FIG. 3A shows a powder bed 301 after a scanning process has occurred. The figure shows a top surface of an n^{th} build piece slice 303, which is a slice formed by an energy beam source/deflector 305 scanning an energy beam to fuse powder in an n^{th} powder layer 307 (where n is the number of the powder layer). FIG. 3B shows a state of powder bed 301 after a next powder layer, i.e., n^{th}+1 powder layer 309, has been deposited. The figure also shows an outline of the next slice to be fused, i.e., an outline of n^{th}+1 slice 311. The state of powder bed 301 in FIG. 3B can be the state of the powder beds prior to the exemplary scanning described in FIGS. 4A-C, FIGS. 5A-D, and FIG. 6.

FIGS. 4A-C illustrate an exemplary vector scanning method for PBF. FIG. 4A illustrates a scan path 401 for the vector scanning in a top view of a powder layer 403. The figure also shows a slice outline 405, showing where the slice is to be formed by the vector scanning. In this example, scan path 401 can be a spiral shape with a beginning 407 at an outside of the spiral and an end 409 at the center of the spiral. At beginning 407, the energy beam is turned on and stays on throughout the entire scan path 401, as represented by the scan path being a dark line labeled beam on 411. At end 409, the energy beam is turned off, and the slice is completed. FIGS. 4B-C show perspective views at different points of time during the scanning.

FIG. 4B shows the scanning at an early point of time at which an energy beam 413 from an energy beam source/deflector 415 has scanned through a first part of scan path 401 to form fused powder 417. The figure also shows a part of scan path 401 that energy beam 413 is scanning over next.

FIG. 4C shows the scanning at a later point of time at which energy beam 413 has scanned through more of scan path 401 and formed more fused powder 417. The figure also shows a part of scan path 401 that energy beam 413 is scanning over next.

FIGS. 5A-D, 6, and 7 illustrate exemplary embodiments of applying a PBF energy beam by raster scanning.

FIGS. 5A-D illustrate an exemplary raster scanning method for PBF. FIG. 5A illustrates a scan path 501 for the raster scanning in a top view of a powder layer 503. The figure also shows a slice outline 505, showing where the slice is to be formed by the raster scanning. In this example, scan path 501 can be a zig-zag shape with a beginning 507 at the top, left corner (as viewed in the figure) of powder layer 503 and an end 509 at the bottom, right corner of the powder layer. The scan pattern is horizontal lines connected by diagonal lines. As the energy beam is scanned across the horizontal lines of scan path 501, the energy beam can be turned on when passing over areas of powder to be fused, and can be turned off when passing over areas of powder not to be fused. For example, FIG. 5A shows beam off 511 (represented by dotted lines) for horizontal lines of scan path 501 that are outside of slice outline 505, and shows beam on 513 (represented by dark lines) for horizontal lines of the scan path that are inside of the slice outline. The diagonal lines of scan path 501 can be for returning to the beginning (i.e., the right end in the figure) of the next horizontal line, which can be referred to a resetting. Therefore, the energy beam can be turned off when scanned through the diagonal lines, which is shown as reset (beam off) 515.

At beginning 507, in this example, the energy beam is turned off and stays off for the first two horizontal lines of scan path 501. The third line through ninth horizontal lines of scan path 501 includes portions during which the energy beam is turned on to fuse powder in areas within slice outline 505. In the remaining horizontal lines, the energy beam is not turned on.

FIGS. 5B-D show perspective views at different points of time during the scanning.

FIG. 5B shows the scanning at an early point of time at which an energy beam source/deflector 517 turns off the energy beam in the initial part of scan path 501, which does not pass over an area in powder layer 503 to be fused. FIG. 5C shows the scanning at a later point in time at which energy beam source/deflector 517 has turned on an energy beam 519 along parts of horizontal scan lines of scan path 501 that are inside of slice outline 505 to form fused powder 521. FIG. 5D shows the scanning at an even later point in time at which energy beam source/deflector 517 has turned on an energy beam 519 along parts of more horizontal scan lines of scan path 501 that are inside of slice outline 505 to form more fused powder 521.

FIG. 6 illustrates another exemplary raster scanning method for PBF. FIG. 6 shows a scan path 601 for raster scanning in a top view of a powder layer 603. The figure also shows a slice outline 605, showing where the slice is to be formed by the raster scanning. In this example, scan path 601 can include horizontal lines connected at ends by vertical lines. Scan path 601 can have a beginning 607 at the top, left corner (as viewed in the figure) of powder layer 603 and an end 609 at the bottom, right corner of the powder layer. As the energy beam is scanned across the horizontal lines of scan path 601, the energy beam can be turned on when passing over areas of powder to be fused, and can be turned off when passing over areas of powder not to be fused. For example, FIG. 6 shows beam off 611 (represented by dotted lines) for horizontal lines of scan path 601 that are outside of slice outline 605, and shows beam on 613 (represented by dark lines) for horizontal lines of the scan path that are inside of the slice outline. The vertical lines of scan path 601 can be for advancing to the next horizontal line, which can be referred to a resetting. Therefore, the energy beam can be turned off when scanned through the vertical lines, which is shown as reset (beam off) 615.

At beginning 607, in this example, the energy beam is turned off and stays off for the first two horizontal lines of scan path 601. The third line through ninth horizontal lines of scan path 601 includes portions during which the energy beam is turned on to fuse powder in areas within slice outline 605. In the remaining horizontal lines, the energy beam is not turned on.

The exemplary embodiments illustrated in FIGS. 5A-D and FIG. 6 are merely two examples of raster scanning, but other scan paths can be used. For example, various embodiments could use different scan path shapes, different path beginnings and/or path ends, different resetting, etc.

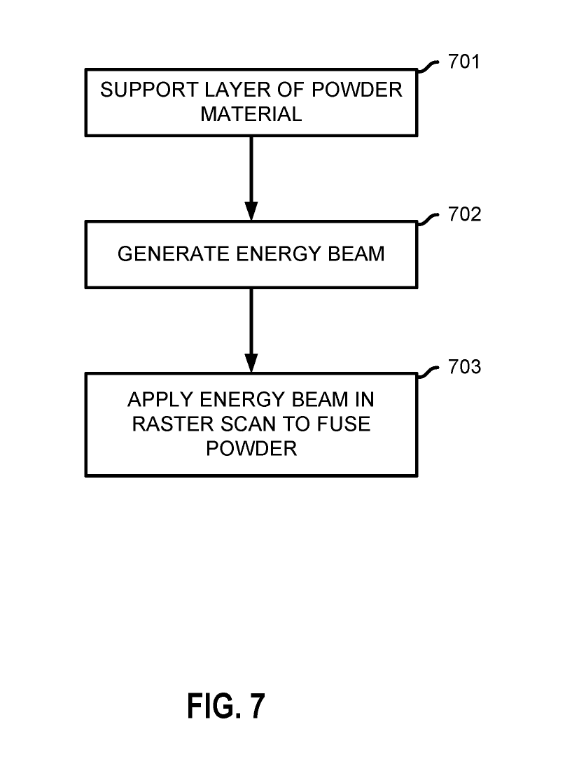

FIG. 7 is a flowchart of an exemplary method of raster scanning for PBF. A layer of powder can be supported (701). For example, a powder bed can support a next layer of powder material, and the powder bed can be supported by a build plate, such as described above with respect to FIGS. 1A-D. An energy beam can be generated (702). For example, an energy beam source such as energy beam source 103 can generate an energy beam. Another example can be focused electron beam 209 generated by electron grid 201, electron grid modulator 203, and focus 205. The energy beam can be applied in a raster scan (703) to fuse powder in the layer. For example, a scan path such as scan path 501, scan path 601, etc., can be used.

FIGS. 8A-C illustrate an exemplary raster scanning method including subdividing the PBF work area. FIG. 8A shows a workspace 801, which represents a powder layer to be scanned. In this regard, it should be understood that workspace 801 is not a physical structure, but is a data structure that represents a physical structure, i.e., a powder layer to be scanned, and that can be used to control the scanning of the powder layer. For example, controller 206 of FIG. 2 may use such a workspace to control the scanning of powder layer 211.

Workspace 801 can be divided into rows and columns, for example, to create subdivisions 803. In FIG. 8A, workspace 801 is divided into 10 rows (in a y-direction) and 10 columns (in an x-direction), i.e. a 10×10 resolution, for a total of 100 subdivisions 803. Although a 10×10 resolution is shown for sake of understanding, in various applications the resolution would likely be significantly higher. In various embodiments, each subdivision 803 can be approximately the same size as a beam area 805, which is the cross-sectional area of the energy beam that will be applied to the powder layer represented by work area 801.

FIG. 8A shows a fusing area 807, which represents an area of the powder layer to which the energy beam will be applied to fuse powder. As shown in the figure, fusing area 807 can coincide with certain ones of subdivisions 803. Thus, fusing area 807 can be represented by the coincident subdivisions 803. In this way, for example, energy beam modulation during a raster scan may be controlled based on which subdivisions coincide with a fusing area (i.e., beam on) and which subdivisions do not coincide with a fusing area (i.e., beam off). In this sense, the workspace can be digitized, or “pixelated,” which may improve an efficiency of raster scanning.

FIG. 8B shows a scan path 809 across a powder layer 810. Scan path 809 can include beam off 811 portions, beam on 813 portions, and reset (beam off) 815 portions. An outline of fusing area 807 is shown as slice outline 817. As illustrated by FIG. 8B, scanning can be controlled such that beam off 811 portions of scan path 809 can correspond to subdivisions 803 that do not include a portion of fusing area 807, and beam on 813 portions can correspond to the subdivisions that include a portion of the fusing area.

FIG. 8C illustrates beam deflection control (x-deflection voltage graph 819 and y-deflection voltage graph 821) and beam power control (beam power graph 823) for the raster scan shown in FIG. 8B. For the first row of subdivisions, i.e., y=1 and x=1-10, x-deflection voltage can steadily increase from a maximum negative voltage corresponding to beam deflection to the left-most column of subdivisions 803 (as seen in figure) to a maximum positive voltage corresponding to beam deflection to the right-most column of subdivisions. The y-deflection voltage can remain constant at a maximum negative voltage corresponding to the maintaining a constant y-deflection across the first row. Because subdivisions 803 in the first row do not include a portion of fusing area 807, beam power remains off for the first row. During a reset period, x-deflection voltage can be reduced to maximum negative, and y-deflection voltage can increase from maximum negative to a value that corresponds to a y-deflection across the second row.

For the second row of subdivisions, i.e., y=2 and x=1-10, x-deflection voltage can again steadily increase from a maximum negative voltage corresponding to beam deflection to the left-most column of subdivisions 803 to a maximum positive voltage corresponding to beam deflection to the right-most column of subdivisions. The y-deflection voltage can remain constant at the voltage corresponding to the maintaining a constant y-deflection across the second row. The beam power can remain off while the beam is deflected toward the first subdivision 803 (i.e., x=1) in the second row. However, when the beam is scans across subdivisions x=2 to x=9, the beam power can turn on. The beam power can turn off for subdivision x=10 in the second row. Then, the scanning can reset again by reducing x-deflection voltage to maximum negative and increasing y-deflection voltage from the value that corresponds to a y-deflection across the second row to a value that corresponds to a y-deflection across the third row.

For the third row of subdivisions, i.e., y=3 and x=1-10, x-deflection voltage can again steadily increase from a maximum negative voltage corresponding to beam deflection to the left-most column of subdivisions 803 to a maximum positive voltage corresponding to beam deflection to the right-most column of subdivisions. The y-deflection voltage can remain constant at the voltage corresponding to the maintaining a constant y-deflection across the third row. The beam power can remain off while the beam is deflected toward the first subdivision 803 (x=1) in the second row, can turn on for subdivision x=2, turn off for subdivisions x=3 to x=8, turn on for subdivision x=9, and turn off for subdivision x=10. The scanning can reset again by reducing x-deflection voltage to maximum negative and increasing y-deflection voltage from the value that corresponds to a y-deflection across the third row to a value that corresponds to a y-deflection across the fourth row. Scanning can proceed in this manner until the entire powder layer 810 is scanned.

FIGS. 9A-D and 10 illustrate an exemplary embodiment of multi-pass scanning for a PBF energy beam. In various embodiments, the energy beam can be applied by multi-pass scanning, in which the energy beam is scanned across the work area multiple times for a single fusing operation. In other words, the energy beam can be applied to fuse an area of the powder material in the layer at multiple locations in such a way that the energy beam is applied to each of the locations multiple times. In some embodiments, the energy beam can also be applied one or more times to other locations in the powder layer, for example, in an area around the area to be fused, such as in the example of FIGS. 9A-D. However, it should be understood that multi-pass scanning includes implementations that apply the energy beam only in the fusing area, the energy beam being applied multiple times.

FIGS. 9A-D illustrate an exemplary multi-pass scanning method. In this example, a raster scan is used. However, in various embodiments multi-pass scanning can be implemented using other scanning methods, such as vector scanning. FIG. 9A illustrates a first pass 901 in an example multi-pass scan. FIG. 9A shows a powder layer 903, a scan path 905, and a slice outline 907 around a fusing area 909. The figure also shows a first beam application 911 in which an energy beam is applied to fusing area 909 as well as an area surrounding the fusing area. First beam application can heat fusing area 909 and the surrounding area to a temperature near the melting point of the powder, but below the melting point. In this way, for example, the area surrounding fusing area 909 can be heated together with the fusing area, which may, for example, result in less internal stress in the slice formed by fusing powder in the fused area.

FIG. 9B illustrates a second pass 913 in the example multi-pass scan. In second pass 913, the powder in fusing area 909 is melted by second beam application 915 (the melted powder shown in next figure, FIG. 9C). Specifically, after first beam application 911 heats fusing area 909 to a temperature below the melting point of the powder, second beam application 915 can heat the fusing area to a temperature above the melting point.

FIG. 9C illustrates a third pass 917 in the example multi-pass scan. In third pass 917, deflection control can follow scan path 905 as in the previous passes. However, the energy beam can remain off for the entire scan path 905. In this way, for example, the temperature of melted powder 919 in fusing area 909 can be allowed to cool. Although, deflection control follows the scan path as a third pass in this example, it should be understood that in various implementations the deflection control may simply not scan during this time, i.e., not perform a pass. However, by maintaining deflection control following the scan path even during passes with no beam application, electronic control circuitry may be simplified, for example, in some embodiments.

FIG. 9D illustrates a fourth pass 921 in the example multi-pass scan. In fourth pass 921, the energy beam is applied to fusing area 909 and the area surrounding the fusing area in a third beam application 923. In this way, for example, the cooling of melted powder 919 can be controlled (i.e., reducing the rate of cooling). In addition, the reheating of the area surrounding fusing area 909, without melting the powder in the surrounding area, may further reduce stresses that can form as melted powder 919 cools to form fused powder 925 (shown in FIG. 9D for purpose of illustration).

In this example, the scan paths in each of the passes are the same. However, in various embodiments the scan paths can be different. For example, a first scan path may include a raster scan of the entire powder layer, while a second scan path may include only a fusing area plus an area surrounding the fusing area, a third scan path may include only a vector scan path in the fusing area, and a fourth scan path may include a different vector scan path in the fusing area.

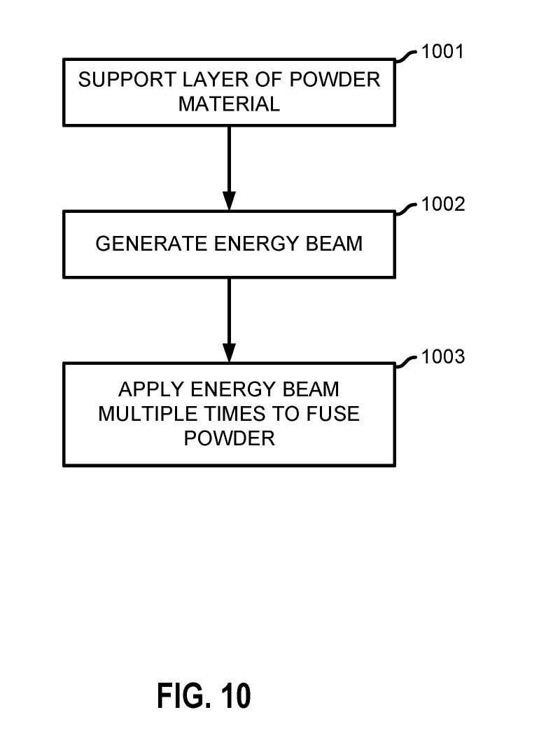

FIG. 10 is a flowchart of an exemplary method of multi-pass scanning for PBF. A layer of powder can be supported (1001). For example, a powder bed can support a next layer of powder material, and the powder bed can be supported by a build plate, such as described above with respect to FIGS. 1A-D. An energy beam can be generated (1002). For example, an energy beam source such as energy beam source 103 can generate an energy beam. Another example can be focused electron beam 209 generated by electron grid 201, electron grid modulator 203, and focus 205. The energy beam can be applied multiple times (1003) to fuse an area of the powder material in the layer at a plurality of locations.

In some embodiments, multi-pass scanning can be used to control a temperature profile of the build piece, an area including the build piece, the entire powder layer, etc. As described above, for example, FIGS. 9A-D illustrate an example implementation of multi-pass scanning in which the temperature of the fusing area and an area surrounding the fusing area can be controlled to allow controlled heating, such as preheating, and controlled cooling.

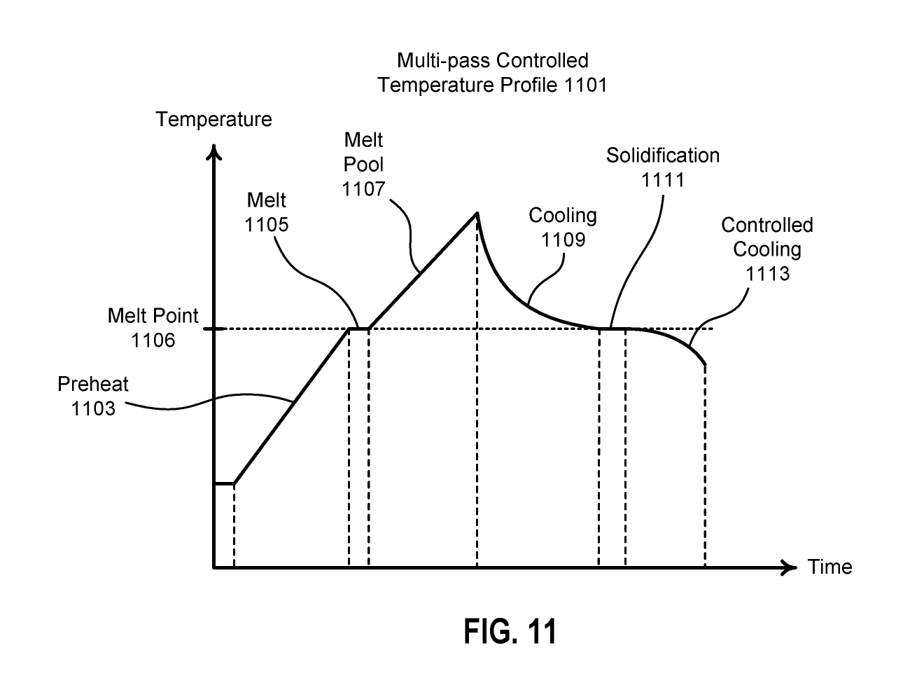

FIG. 11 illustrates an exemplary multi-pass controlled temperature profile 1101 of a fusing area. Multi-pass controlled temperature profile 1101 can include a preheat 1103, in which a first beam application can heat the fusing area to a temperature below the melting point. During a melt 1105 period, the energy beam continues to be applied, and the powder transitions from solid to liquid. Melt point 1106 line represents the melting temperature of the powder. During a melt pool 1107 period, the energy beam continues to be applied until the melt pool reaches a peak temperature, and then the energy beam is turned off, at which point the melted powder starts to cool during a cooling 1109 period. The cooling melted powder reaches melt point 1106 and transitions from liquid to solid during a solidification 1111 period. During a controlled cooling 1113 period, the cooling temperature is controlled by periodic application of the energy beam.

In other words, multi-pass scanning can be implemented to control the amount of energy deposited into the powder layer over time (e.g., a rate of energy deposition).

In various embodiments, temperature can be controlled based on a model, e.g., a physics-based thermal model of heating and cooling mechanisms of the build piece, loose powder, etc. In various embodiments, temperature control can be based on a temperature feedback system. For example, temperature sensor 122 of FIGS. 1A-D can sense the temperature of melted powder and a scanning controller, such as controller 206 of FIG. 2, can use the temperature information to control the multi-pass scanning to achieve a desired controlled cooling. In various embodiments, the temperature profile of other areas, such as loose powder areas like an area surrounding a fusing area, the entire powder bed, etc., can be controlled.

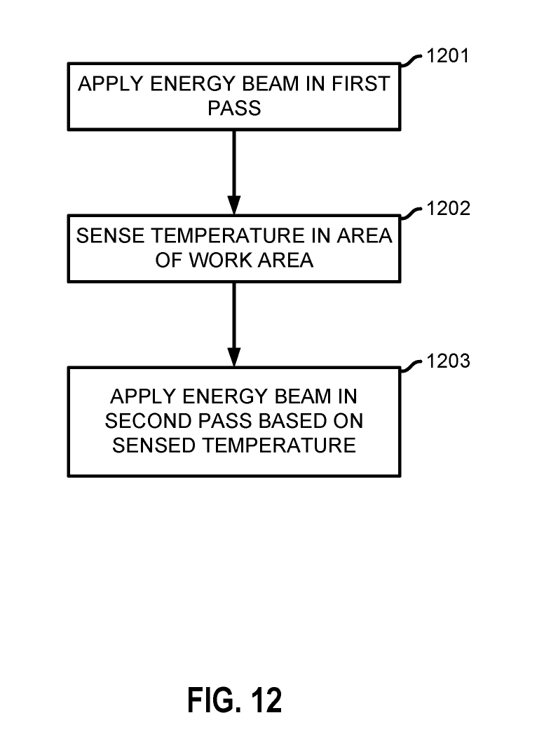

FIG. 12 is a flowchart of an exemplary method of multi-pass temperature profile control for PBF. The method includes applying (1201) an energy beam in a first pass and sensing (1202) a temperature in an area of the work area after the first beam application. For example, a temperature sensor such as temperature sensor 122 can be used to sense the temperature of melted powder in a fusing area to determine if the temperature is low enough for a second beam application. The energy beam can be applied (1203) in a second pass based on the sensed temperature. For example, if the temperature of the melted powder is dropping too quickly, a second beam application can be applied to slow the rate of cooling.

In various embodiments, by scanning the entire fusing area, controlled sintering/melting temperature profiles can be implemented. The entire fusing area can be exposed in a manner that allows for controlled warming, melting, cooling, and stress relief. For example, in the warming stage the energy beam power can be increased for greater penetration and faster scan speeds to widen the thermal gradient of the build piece to prevent thermal stresses that will result in builds with lower internal stresses and better dimensional tolerancing. Thermal cameras and thermocouples placed in the powder bed can provide temperature feedback.

In various embodiments, controlling the amount of energy deposited can include controlling a time between the application of the energy beam for each of the locations, for example, by making a scanning pass without applying the energy beam. In various embodiments, controlling the amount of energy deposited can include controlling a number of times the energy beam is applied to each of the locations, for example, the energy beam in the example of FIGS. 9A-D is applied to the fusing area three times, and is applied to the area surrounding the fusing area twice. In various embodiments, controlling the amount of energy deposited can include controlling a power of the energy beam. In this case, for example, different beam powers can be used in different passes of a multi-pass scanning. For example, a different beam power can be used for preheating that is used for controlled cooling.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for powder-bed fusion, comprising:
a structure that supports a layer of powder material;
an energy beam source that generates an energy beam; and
a deflector that applies the energy beam to fuse an area of the powder material in the layer at a plurality of locations, wherein the deflector is further configured to apply the energy beam to each of the locations a plurality of times.

2. The apparatus of claim 1, wherein the deflector is further configured to apply the energy beam via a raster scan.

3. The apparatus of claim 2, wherein the energy beam source is further configured to modulate the energy beam during the raster scan.

4. The apparatus of claim 3, wherein the energy beam source comprises a digital signal processor that modulates the energy beam during the raster scan.

5. The apparatus of claim 1, further comprising a temperature controller that controls an amount of energy deposited based on the temperature of the powder material layer while the deflector applies the energy beam.

6. The apparatus of claim 5, wherein the temperature controller is further configured to control the amount of energy deposited based on the temperature of the powder material layer by controlling a time between the application of the energy beam for each of the locations.

7. The apparatus of claim 5, wherein the temperature controller is further configured to control the amount of energy deposited based on the temperature of the powder material layer by controlling a number of times the energy beam is applied to each of the locations.

8. The apparatus of claim 5, wherein the temperature controller is further configured to control the amount of energy deposited based on the temperature of the powder material layer by controlling a power of the energy beam.

9. The apparatus of claim 5, wherein the temperature controller includes a temperature sensor that senses a temperature of the area, and the temperature controller is configured to control the temperature of the powder material layer based on the sensed temperature.

10. The apparatus of claim 5, wherein the temperature controller is further configured to control the deflector to apply the energy beam to the area of the powder material during a period of time that the temperature of the area of the powder material is decreasing, such that a rate of cooling of the area is modified.

11. The apparatus of claim 5, wherein the temperature controller is further configured to control the deflector to apply the energy beam to the area of the powder material to preheat the area of the powder material without fusing the powder material.

12. The apparatus of claim 11, wherein the temperature controller is further configured to control the deflector to preheat a larger area around the area of the powder material.

13. An apparatus for powder-bed fusion, comprising:
a powder material support structure;
an energy beam source directed to the powder material support surface;
a deflector configured to provide a plurality of scans to a layer powder material supported by the structure.

14. The apparatus of claim 13, wherein the deflector includes a raster scanner.

15. The apparatus of claim 13, wherein the energy beam source is further configured produce a modulated energy beam during a raster scan of the raster scanner.

16. The apparatus of claim 13, further comprising a temperature controller that controls the amount of energy deposited based on the temperature of the powder material layer during the scans.

17. The apparatus of claim 16, wherein the temperature controller is further configured to control the amount of energy deposited based on the temperature of the powder material layer by controlling a time between the scans.

18. The apparatus of claim 16, wherein the temperature controller is further configured to control the amount of energy deposited based on the temperature of the powder material layer by controlling a number of the scans.

19. The apparatus of claim 16, wherein the temperature controller is further configured to control the amount of energy deposited based on the temperature of the powder material layer by controlling a duration of each of the scans.

20. The apparatus of claim 16, wherein the temperature controller is further configured to control the amount of energy deposited based on the temperature of the powder material layer by controlling the energy beam source to control a power of the energy beam.

21. The apparatus of claim 16, wherein the temperature controller includes a temperature sensor arranged with the powder material support structure, and the temperature controller is configured to control the temperature of the powder material based on a temperature sensed by the temperature sensor.

22. An apparatus for powder-bed fusion, comprising:
a structure that supports a layer of powder material;
an energy beam source that generates an energy beam; and
a deflector that applies the energy beam to fuse an area of the powder material in the layer at a plurality of locations, wherein the deflector is further configured to apply the energy beam in a raster scan.

23. The apparatus of claim 22, wherein the energy beam source is further configured to modulate the energy beam during the raster scan.

24. The apparatus of claim 23, wherein the energy beam source comprises a digital signal processor that modulates the energy beam during the raster scan.

25. The apparatus of claim 22, further comprising a temperature controller that controls an amount of energy deposited based on the temperature of the powder material layer while the deflector applies the energy beam.

26. The apparatus of claim 25, wherein the temperature controller is further configured to control the amount of energy deposited based on the temperature of the powder material layer by controlling a time between the application of the energy beam for each of the locations.

27. The apparatus of claim 25, wherein the temperature controller is further configured to control the amount of energy deposited based on the temperature of the powder material layer by controlling a number of times the energy beam is applied to each of the locations.

28. The apparatus of claim 25, wherein the temperature controller is further configured to control the amount of energy deposited based on the temperature of the powder material layer by controlling a power of the energy beam.

29. The apparatus of claim 25, wherein the temperature controller includes a temperature sensor that senses a temperature of the area, and the temperature controller is configured to control the temperature of the powder material layer based on the sensed temperature.

30. The apparatus of claim 25, wherein the temperature controller is further configured to control the deflector to apply the energy beam to the area of the powder material during a period of time that the temperature of the area of the powder material is decreasing, such that a rate of cooling of the area is modified.

31. The apparatus of claim 25, wherein the temperature controller is further configured to control the deflector to apply the energy beam to the area of the powder material to preheat the area of the powder material without fusing the powder material.

32. The apparatus of claim 31, wherein the temperature controller is further configured to control the deflector to preheat a larger area around the area of the powder material.

33. A method for powder-bed fusion, comprising:
supporting a layer of powder material;
generating an energy beam; and
applying the energy beam to fuse an area of the powder material in the layer at a plurality of locations, wherein the energy beam is applied to each of the locations a plurality of times.

34. The method of claim 33, wherein applying the energy beam includes applying the energy beam in raster scan.

35. The method of claim 34, wherein applying the energy beam includes modulating the energy beam during the raster scan.

36. The method of claim 33, further comprising controlling the amount of energy deposited based on the temperature of the powder material layer during the application of the energy beam.

37. The method of claim 36, wherein controlling the amount of energy deposited based on the temperature includes controlling a time between the application of the energy beam for each of the locations.

38. The method of claim 36, wherein controlling the amount of energy deposited based on the temperature includes controlling a number of times the energy beam is applied to each of the locations.

39. The method of claim 36, wherein controlling the amount of energy deposited based on the temperature includes controlling a power of the energy beam.

40. The method of claim 36, wherein controlling the amount of energy deposited based on the temperature is based on a temperature of the powder material sensed by a temperature sensor.

41. The method of claim 36, wherein controlling the amount of energy deposited includes applying the energy beam to the area of the powder material during a period of time that the temperature of the area of the powder material is decreasing, such that a rate of cooling of the area is modified.

42. The method of claim 36, wherein controlling the amount of energy deposited includes applying the energy beam to the area of the powder material to preheat the area of the powder material without fusing the powder material.

43. The method of claim 42, wherein controlling the amount of energy deposited further includes preheating a larger area around the area of the powder material.

44. A method for powder-bed fusion, comprising:
supporting a layer of powder material;
generating an energy beam; and
applying the energy beam to fuse an area of the powder material in the layer at a plurality of locations, wherein the energy beam is applied in a raster scan.

45. The method of claim 44, wherein applying the energy beam includes modulating the energy beam during the raster scan.

46. The method of claim 44, further comprising controlling the amount of energy deposited based on the temperature of the powder material layer during the application of the energy beam.

47. The method of claim 46, wherein controlling the amount of energy deposited based on the temperature includes controlling a time between the application of the energy beam for each of the locations.

48. The method of claim 46, wherein controlling the amount of energy deposited based on the temperature includes controlling a number of times the energy beam is applied to each of the locations.

49. The method of claim 46, wherein controlling the amount of energy deposited based on the temperature includes controlling a power of the energy beam.

50. The method of claim 46, wherein controlling the amount of energy deposited based on the temperature is based on a temperature of the powder material sensed by a temperature sensor.

51. The method of claim 46, wherein controlling the amount of energy deposited includes applying the energy beam to the area of the powder material during a period of time that the temperature of the area of the powder material is decreasing, such that a rate of cooling of the area is modified.

52. The method of claim 46, wherein controlling the amount of energy deposited includes applying the energy beam to the area of the powder material to preheat the area of the powder material without fusing the powder material.

53. The method of claim 52, wherein controlling the amount of energy deposited further includes preheating a larger area around the area of the powder material.
